(19) United States
(12) Patent Application Publication
(10) Pub. No.: US 2013/0073339 A1
(43) Pub. Date: Mar. 21, 2013

(54) DEVICES, SYSTEMS, AND METHODS FOR ACQUIRING UNSOLICITED CONSUMER COMMENTS

(71) Applicant: Chris Hauck, Boulder, CO (US)

(72) Inventor: Chris Hauck, Boulder, CO (US)

(73) Assignee: LYNX RESEARCH CONSULTING, Boise, ID (US)

(21) Appl. No.: 13/235,101

(22) Filed: Sep. 16, 2011

(51) Int. Cl. G06Q 10/00; G06Q 30/00

(52) U.S. Cl. 705/7.32; 705/14.19

(57) ABSTRACT

Methods, systems, and devices are described for acquiring unsolicited consumer comments. Input from a user indicating that the user has one or more unsolicited comments directed to an establishment or an entity associated with a product may be received at a user device. The establishment or the product to which the user has the one or more directed unsolicited comments may be determined at the user device. A comment input interface to receive the one or more unsolicited comments regarding the establishment or the product from the user may be presented through the user device. The one or more unsolicited comments from the user may be received at the user device. The one or more received unsolicited comments may be transmitted, from the user device, to a comment processor system to prepare for presentation to the establishment or the entity associated with the product.

### BACKGROUND

Establishments and product producers often seek input from consumers through the use of surveys. For example, a survey may be provided to the consumer after he or she has bought a product or received a service from the establishment. These surveys may include online or printed surveys in some cases. The surveys may generally include questions that the establishment or product producer may believe will solicit information from the consumer that the establishment or product producer may then utilize—providing better services and/or products to the consumers.

These approaches are generally after the fact, i.e. after a purchase and/or service has been provided, and may not occur in real time when a consumer may be having a consumer experience. These approaches are also generally establishment and/or product producer directed or solicited rather than being consumer directed and/or unsolicited.

### SUMMARY

Embodiments include methods, system, computer-readable medium, and/or devices for acquiring unsolicited consumer comments. A user, for example, may provide input into a user device that may indicate that they would like to direct a comment to an establishment and/or an entity associated with a product. A list of multiple establishment types may be presented to the user through their user device. The user may indicate which establishment type to which they would like to direct a comment. The user device may thus determine a specific establishment type from the multiple establishment types based on input from the user. Having determined the specific establishment type, a list of multiple establishments based on the specific establishment type may be presented to the user through the user device. The user may then select specific establishment from the multiple establishments. The user device may then present a comment input interface to the user to receive the one or more unsolicited comments regarding the specific establishment from the user. In some embodiments, the comment input interface may be configured as a positive comment input interface or a negative comment input interface. The user may then provide their comment such that their one or more unsolicited comments directed to the establishment may be received at the user device. The one or more received unsolicited comments may be transmitting from the user device to a comment processor system to prepare for presentation to the establishment.

Some embodiments may be configured to receive unsolicited comments regarding products that may then be directed to entities associated with the products. Some embodiments may also be able to determine the establishment or product that the consumer would like to provide an unsolicited comment through receiving identifier information associated with a bar code tag or RFID tag. Some embodiments may also utilize location information, such as a GPS location, of the user device to determine an establishment that the user would like to provide an unsolicited comment.

Embodiments may allow for the acquisition of information from consumers in the moment, while they are having an experience. A consumer may determine when to provide the information in an unsolicited fashion rather than having a business establishment, for example, pushing the consumer to provide the information. Embodiments may provide anonymity to consumers providing information or comments directed at a specific establishment or product. Embodiments may allow a consumer to provide comments regarding a wide variety of establishments and/or products rather than being associated with a particular establishment. A consumer may decide what information they want to provide rather than being directed to provide specific information. The unsolicited comments may be received through numerous different types of user devices including mobile devices, such as cell phones. The unsolicited comments may be transmitted to a comment processor where they may prepare for presentation to an establishment or entity associated with a product to which the comments may be directed.

Some embodiments provide a method for acquiring unsolicited consumer comments. The method may include receiving, at a user device, an input from a user indicating that the user has one or more unsolicited comments directed to an establishment. Multiple establishment types may be presented to the user through the user device. A specific establishment type from the multiple establishment types may be determined based on input from the user. Multiple establishments may be determined based on the specific establishment type, such as through a lookup table. Multiple establishments based on at least the determined specific establishment type may be presented to the user, through the user device. A specific establishment from the multiple establishments may be determined based on input from the user. A comment input interface to receive the one or more unsolicited comments regarding the specific establishment from the user may be presented to the user through the user device. The comment input interface may include at least a positive comment window or a negative comment window. The one or more unsolicited comments directed to the establishment from the user may be received at the user device. An incentive interface including a one or more incentives for the user to select may be presented through the user device. A user-selected incentive may be determined from the one or more incentives. The one or more received unsolicited comments may be transmitted from the user device the to a comment processor system to prepare for presentation to the establishment. Information regarding the user-selected incentive may also be transmitted to the comment processor system.

Some embodiments provide a method for acquiring unsolicited consumer comments. The method may include receiving, at a user device, an input from a user indicating that the user has one or more unsolicited comments directed to at least an establishment or an entity associated with a product. The method may include determining, at the user device, at least the establishment or the product that the user has the one or more directed unsolicited comments. The method may include presenting, through the user device, a comment input interface to receive the one or more unsolicited comments regarding at least the establishment or the product from the user. The method may include receiving, at the user device, the one or more unsolicited comments from the user. The method may include transmitting, from the user device, the one or more received unsolicited comments to a comment processor system to prepare for presentation to at least the establishment or the entity associated with the product.

Determining, at the user device, at least the establishment or the product may include presenting to the user, through the user device, multiple establishment types and/or multiple product types. A specific establishment type from the multiple establishment types and/or a specific product type from the multiple product types may be determined based on input from the user. Determining, at the user device, at least the establishment or the product may further include presenting to the user, through the user device, multiple establishments and/or multiple products based on at least the determined specific establishment type or the determined specific product type. At least a specific establishment from the multiple establishments or a specific product of the multiple products may be determined based on input from the user.

Determining, at the user device, at least the establishment or the product may include scanning for at least an establishment identifier or a product identifier. Scanned information may be received identifying at least the establishment or the product associated with at least the establishment identifier or the product identifier.

In some embodiments, the comment input interface may include at least a positive comment window or a negative comment window. The method for acquiring unsolicited consumer comments may further include presenting to the user, through the user device, at least a positive comment and a negative comment choice. The positive comment choice or the negative comment choice may be determined based on input from the user. Presenting, through the user device, the comment input interface may include presenting at least the positive comment window or the negative comment window based on the determined positive comment choice or the determined negative comment choice.

In some embodiments, the method for acquiring unsolicited consumer comments may further include transmitting to the comment processor system additional data including at least a time of day, a date, or a location of the user device. In some embodiments, the method for acquiring unsolicited consumer comments may further include presenting, through the user device, an incentive interface comprising a one or more incentives for the user to select. A user-selected incentive may be determine from the one or more incentives. Information regarding the user-selected incentive may be transmitted to at least the comment processor, the establishment, or the entity associated with the product.

Some embodiments provide a user device for acquiring unsolicited consumer comments. The user device may include an input module configured to: receive an input from a user indicating that the user has one or more unsolicited comments directed to at least an establishment or an entity associated with a product; and/or receive the one or more unsolicited comments from the user. The user device may include an establishment-product determination module configured to determine at least the establishment or the product that the user has the one or more directed unsolicited comments. The user device may include a comment module configured to present a comment input interface to receive the one or more unsolicited comments regarding at least the establishment or the product from the user. The user device may include a transmitter module configured to transmit the one or more received unsolicited comments to a comment processor system to prepare for presentation to at least the establishment or the entity associated with the product.

The establishment-product determination module configured to determine at least the establishment or the product may be configured to: present to the user at least a plurality of establishment types or a plurality of product types; and/or determine at least a specific establishment type from the plurality of establishment types or a specific product type from the plurality of product types based on input from the user. The establishment-product determination module configured to determine at least the establishment or the product may be further configured to: present to the user multiple establishments and/or multiple products based on at least the determined specific establishment type or the determined specific product type; and/or determine at least a specific establishment from the multiple establishments or a specific product of the multiple products based on input from the user.

The establishment-product determination module configured to determine at least the establishment or the product may be configured to: scan for at least an establishment identifier or a product identifier; and/or receive scanned information identifying at least the establishment or the product associated with at least the establishment identifier or the product identifier.

The comment module configured to present the comment input interface may be configured to at least a positive comment window or a negative comment window. The comment module configured to present a comment input interface may be further configured to: present to the user at least a positive comment and a negative comment choice; and/or determine the positive comment choice or the negative comment choice based on input from the user. Presenting the comment input interface may include presenting at least the positive comment window or the negative comment window based on the determined positive comment choice or the determined negative comment choice.

In some embodiments, the transmitter module may be further configured to transmit to the comment processor system additional data including at least a time of day, a date, or a location of the user device. In some embodiments, the user device is a mobile device.

In some embodiments, the user device may further include an incentive module configured to: present an incentive interface comprising a one or more incentives for the user to select; determine a user-selected incentive from the one or more incentives; and/or transmit information regarding the user-selected incentive to at least the comment processor, the establishment, or the entity associated with the product.

Some embodiments provide a computer program product for acquiring unsolicited consumer comments on a tangible processor-readable medium and including processor-readable instructions, which, when executed, cause a processor to perform steps including: receiving, at a user device, an input from a user indicating that the user has one or more unsolicited comments directed to at least an establishment or an entity associated with a product; determining, at the user device, at least the establishment or the product that the user has the one or more directed unsolicited comments; presenting, through the user device, a comment input interface to receive the one or more unsolicited comments regarding at least the establishment or the product from the user; receiving, at the user device, the one or more unsolicited comments from the user; and/or transmitting, from the user device, the one or more received unsolicited comments to a comment processor system to prepare for presentation to at least the establishment or the entity associated with the product.

Determining, at the user device, at least the establishment or the product may include: presenting to the user, through the user device, multiple establishment types and/or multiple product types; and/or determining at least a specific establishment type from the multiple establishment types or a specific product type from the multiple product types based on input from the user.

Determining, at the user device, at least the establishment or the product may further include: presenting to the user, through the user device, multiple establishments and/or multiple products based on at least the determined specific establishment type or the determined specific product type; and/or determining at least a specific establishment from the multiple establishments or a specific product of the multiple products based on input from the user.

Determining, at the user device, at least the establishment or the product may include: scanning for at least an establishment identifier or a product identifier; and/or receiving scanned information identifying at least the establishment or the product associated with at least the establishment identifier or the product identifier.

The comment interface may include at least a positive comment window or a negative comment window. Some embodiments may further include: presenting to the user, through the user device, at least a positive comment and a negative comment choice; and/or determining the positive comment choice or the negative comment choice based on input from the user. Presenting, through the user device, the comment input interface may include presenting at least the positive comment window or the negative comment window based on the determined positive comment choice or the determined negative comment choice.

Some embodiments may further include transmitting to the comment processor system additional data including at least a time of day, a date, or a location of the user device. Some embodiments may further include presenting an incentive interface comprising a one or more incentives for the user to select; determining a user-selected incentive from the one or more incentives; and/or transmitting information regarding the user-selected incentive to at least the comment processor, the establishment, or the entity associated with the product.

The foregoing has outlined rather broadly examples according to disclosure in order that the detailed description that follows may be better understood. Additional features will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A, 1B, 1C, 1D, and 1E show different configurations of a user device configured to acquire unsolicited consumer comments in accordance with various embodiments;

FIGS. 2A and 2B show different configurations of a user device configured to acquire unsolicited consumer comments in accordance with various embodiments;

FIG. 3A shows a block diagram of a device configured for acquiring unsolicited consumer comments in accordance with various embodiments;

FIG. 3B shows a block diagram of a user device configured for acquiring unsolicited consumer comments in accordance with various embodiments;

FIG. 4 is a flowchart of a method for acquiring unsolicited user comments in accordance with various embodiments;

FIG. 5 is a flowchart of a method for acquiring unsolicited user comments in accordance with various embodiments;

FIG. 6 is a computer system in accordance with various embodiments; and

FIG. 7 is a communication network system diagram that includes user devices in accordance with various embodiments.

### DETAILED DESCRIPTION

Embodiments include methods, system, computer-readable medium, and/or devices for acquiring unsolicited consumer comments. A user, for example, may provide input into a user device that may indicate that they would like to direct a comment to an establishment and/or product. A list of multiple establishment types may be presented to the user through their user device. The user may indicate which establishment type to which they would like to direct a comment. The user device may thus determine a specific establishment type from the multiple establishment types based on input from the user. Having determined the specific establishment type, a list of multiple establishments based on the specific establishment type may be presented to the user through the user device. The user may then select specific establishment from the multiple establishments. The user device may then present a comment input interface to the user to receive the one or more unsolicited comments regarding the specific establishment from the user. In some embodiments, the comment input interface may be configured as a positive comment input interface or a negative comment input interface. The user may then provide their comment such that their one or more unsolicited comments directed to the establishment may be received at the user device. The one or more received unsolicited comments may be transmitting from the user device to a comment processor system to prepare for presentation to the establishment.

Some embodiments may be configured to receive unsolicited comments regarding products that may then be directed to entities associated with the products. Some embodiments may also be able to determine the establishment or product to which the consumer would like to provide an unsolicited comment through receiving identifier information associated with a bar code tag or RFID tag. Some embodiments may also utilize location information, such as a GPS location, of the user device to determine an establishment to which the user would like to provide an unsolicited comment.

Embodiments may allow for the acquisition of information from consumers in the moment, while they are having an experience. A consumer may determine when to provide the information in an unsolicited fashion rather than having a business establishment, for example, pushing the consumer to provide the information. Embodiments may provide anonymity to consumers providing information or comments directed at a specific establishment or product. Embodiments may allow a consumer to provide comments regarding a wide variety of establishments and/or products rather than being associated with a particular establishment. A consumer may decide what information they want to provide rather than being directed to provide specific information. The unsolicited comments may be received through numerous different types of user devices including mobile devices, such as cell phones. The unsolicited comments may be transmitted to a comment processor where they may prepare for presentation to an establishment or entity associated with a product to which the comments may be directed.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

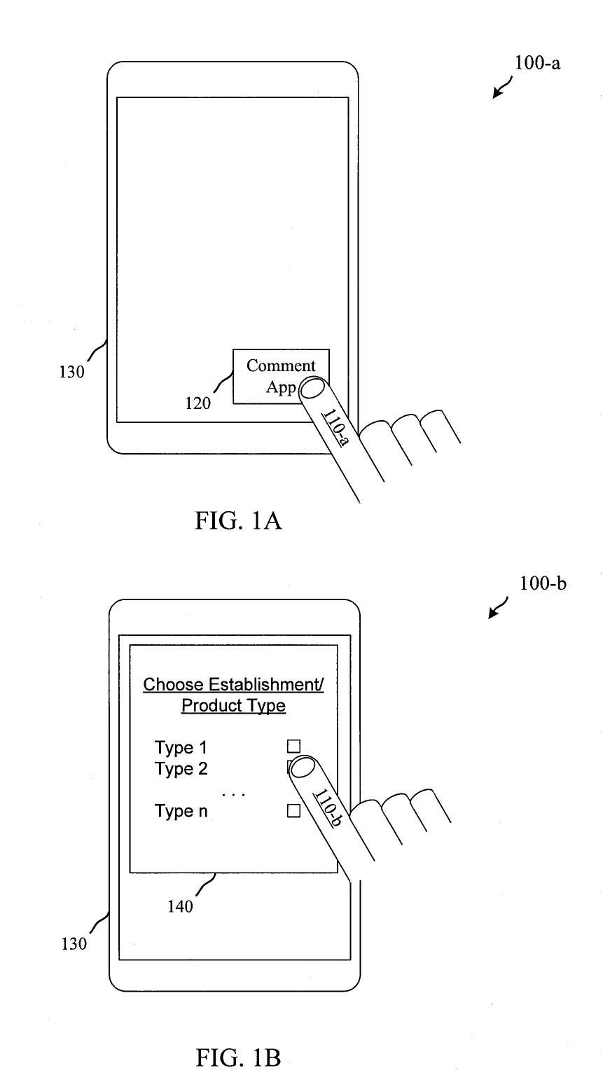

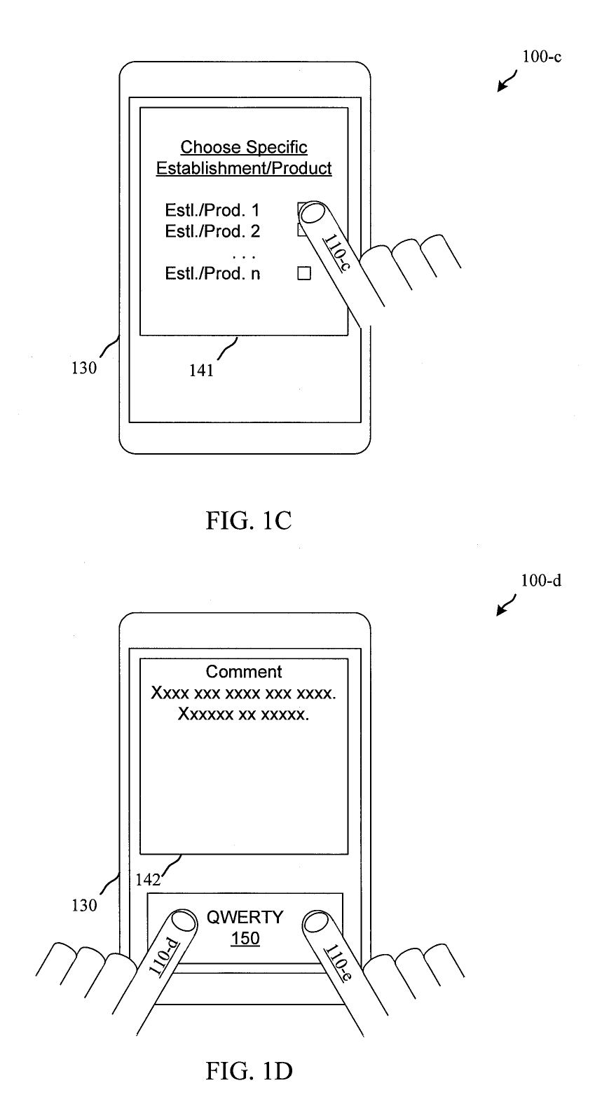

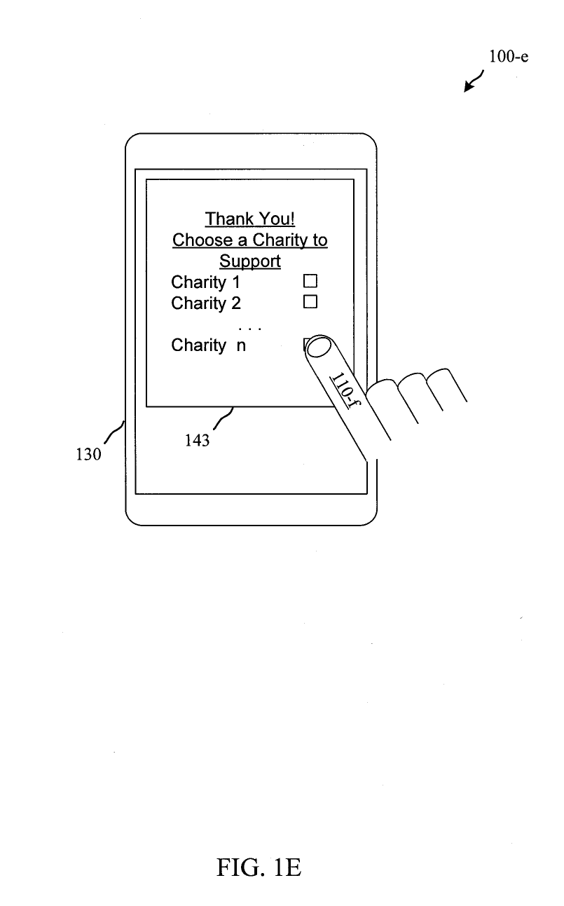

Referring first to FIG. 1A, a configuration 100-a is shown with a user device 130 and user means for inputting information into the user device 130, in this case, a user's finger 110-a. In this example, user device 130 may be configured with a touch display to receive input from the user. In some embodiments, a user may provide input through a keyboard or other known input methods. In general, user device 130 may include a wide variety of user devices including, but not limited to, personal computers (e.g., laptop computers, net book computers, tablet computers, etc.), cellular telephones, PDAs, digital video recorders (DVRs), internet appliances, gaming consoles, e-readers, etc. In some cases, the user device 130 may be a mobile device.

A user may launch a comment application 120 in some embodiments. Other embodiments may include configurations where a user may indicate that they have a comment through opening an application window, pulling down a menu item from an application window, and/or otherwise indicating that they may have a comment. In some cases, the user may indicate that they have one or more unsolicited comments regarding an establishment or product by launching an application such as the comment application 120.

FIG. 1B shows a configuration 100-b where a user may indicate that the user has one or more unsolicited comments to direct at an establishment and/or product type. In this example, an application window 140 presenting a list of different establishment types and/or product types is provided. Establishment types may include a wide variety of establish types including, but not limited to, airlines, automotive dealers, automotive repair shops, entertainment, medical, restaurants, retail, venue, etc., merely by way of example. Product types may include a wide variety of product types including, but not limited to, appliances, electronics, books, automotive parts, clothing, shoes, videos, sporting, goods, etc., merely by way of example. A user may provide input indicating one of the establishment types and/or product types that the user wants to comment on; in this case, the user may again utilize their finger 110-b to select the specific establishment type and/or user type. The user device 130 may as a result determine the specific establishment type and/or product type that the user has indicated and/or selected. In some embodiments, information regarding the user indication may be transmitted to another device and/or system where it may be determined which establishment type and/or product type that the user indicated and/or selected. This specific establishment type or product type information may be transmitted back to the user device 130 in some cases.

FIG. 1C shows a configuration 100-c where a user may indicate or select a specific establishment and/or product that they may want to provide one or more unsolicited comments directed at an establishment and/or product. Multiple establishments and/or products may be presented to the user through an application window 141, for example, through the user device 130. The multiple establishments and/or products may be based on the determined specific establishment type and/or product type. Some embodiments may utilize a lookup table to determine the multiple establishments and/or products based on the determined specific establishment type and/or product type. A user may provide input indicating one of the specific establishment and/or product that the user wants to comment on; in this case, the user may again utilize their finger 110-c to select the specific establishment type and/or user type. The user device 130 may as a result determine the specific establishment and/or product that the user has indicated and/or selected. In some embodiments, information regarding the user indication may be transmitted to another device and/or system where it may be determined which establishment and/or product the user indicated and/or selected. This specific establishment or product information may be transmitted back to the user device 130 in some cases.

FIG. 1D shows a configuration 100-d that includes a comment input interface 142 presented through the user device 130 to receive the one or more unsolicited comments regarding the specific establishment and/or product from the user. The comment input interface 142 may include at a positive comment window and/or a negative comment window in some embodiments. The user may provide a comment as shown in configuration 100-d, where a user may input (using their fingers 110-d and/or 110-e in this example) their comment through a QWERTY keyboard 150. The one or more unsolicited comments from the user directed to the specific establishment or entity associated may thus be received at the user device 130.

FIG. 1E shows a configuration 100-e where an additional application window 143 is provided as a form of incentive to the user. In this example, a user may select a specific charity to support, as shown with user finger 110-f selecting “Charity n,” in this example. By selecting a specific charity, a donation or some other form of support may be provided to the charity by one or more entities, such as the comment processor, the specific establishment, and/or the entity associated with the product. This incentive may be provided to encourage users to provide unsolicited comments as discussed above with respect to FIGS. 1A-1D. Different incentives may be provided in other embodiments, including but not limited to, providing coupons, discounts, or other benefits to the user. In general, the incentives are provided in such a way that the user may maintain anonymity.

After a user may have provided one or more unsolicited comments, such as seen in configuration 100-d of FIG. 1D and/or after selecting an incentive as shown in configuration 100-e of FIG. 1E, the received unsolicited comment(s) and/or incentive selection may be transmitted to a comment processor system. The comment(s) may be sent in real-time in some cases. In some embodiments, the comment(s) may be stored on the user device 130 and transmitted at a later time. The comment processor system may prepare the comments for presentation to the establishment and/or entity associated with the product that the consumer has directed their comments towards. In some embodiments, the comments may be sent directly to the establishment and/or entity associated with the product. This information may be encrypted in some cases. The comment information may also be sent such that the user may provide the comments while maintaining their anonymity.

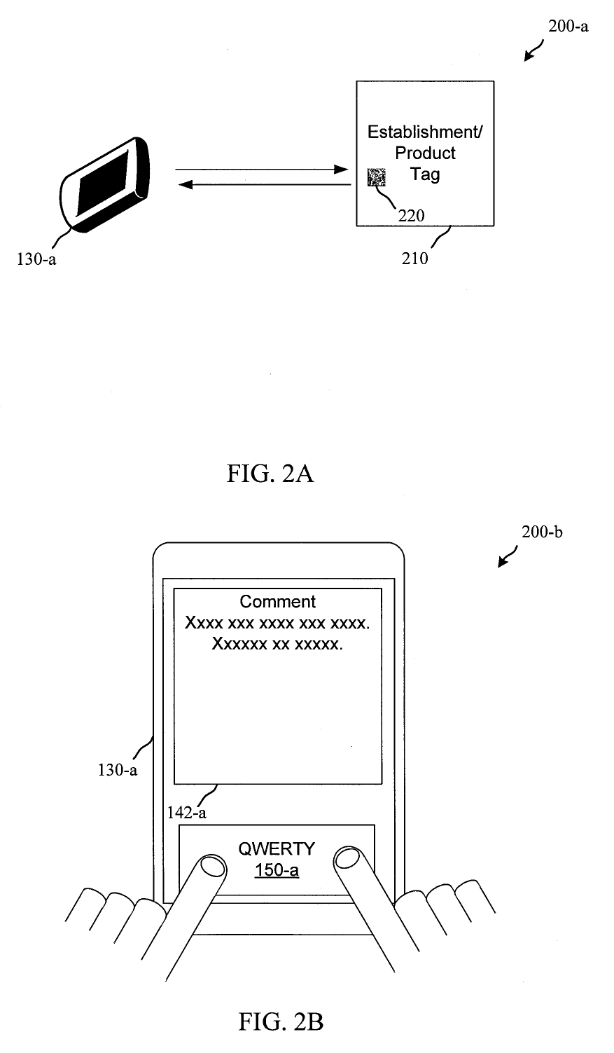

Turning now to FIG. 2A, a system 200-a in accordance with various embodiments is shown that includes a user device 130-a along with an establishment and/or product tag 210. The establishment and/or product tag may include a establishment and/or product identifier 220. The establishment and/or product identifier 220 may include, but is not limited to, bar codes, RFID tags, and other means of identifying the establishment and/or product. Device 130-a may be an example of device 130 of FIG. 1.

As shown in FIG. 2A, the user device 130-a may scan and/or otherwise determine the establishment identifier or a product identifier 220. The scanned information may be received at the user device 130-a to identify the establishment or the product associated with the establishment identifier or the product identifier 220. In some embodiments, the establishment and/or product identifier 220 may be utilized by the user device 130-a to determine the establishment and/or product associated with the identifier 220. In other cases, the information provided through the identifier 220 may be transmitted to a comment processor system where the establishment and/or product may be identified.

FIG. 2B then shows a configuration 200-b similar to configuration 100-d of FIG. 1D where a user may be presented with a comment user interface 142-a displayed on user device 130-a through which a user may provide a comment as shown in configuration 200-b, where a user may input their comment through a QWERTY keyboard 150-a. The one or more unsolicited comments from the user directed to the specific establishment or entity associated may thus be received at the user device 130. In general, after a user may have provided one or more unsolicited comments, such as seen in configuration 200-b of FIG. 2B, the received unsolicited comment may be transmitted to a comment processor system. The comment processor system may prepare the comments for presentation to the establishment and/or entity associated with a product. In some embodiments, the comments may be sent directly to the establishment and/or entity associated with the product. This information may be encrypted in some cases. The comment information may also be sent such that the user may provide the comments while maintaining their anonymity.

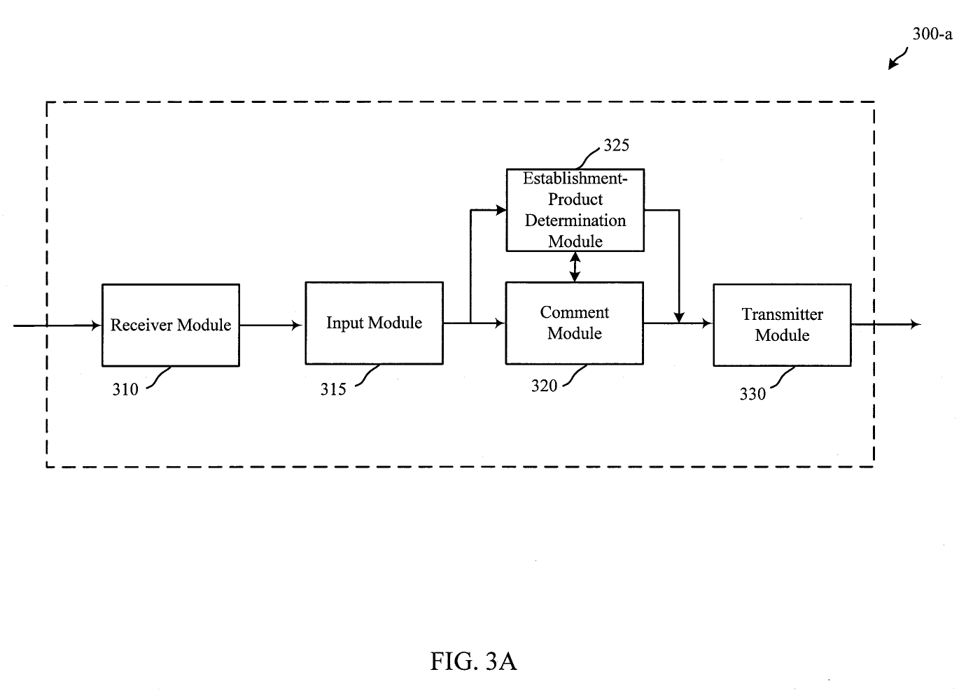

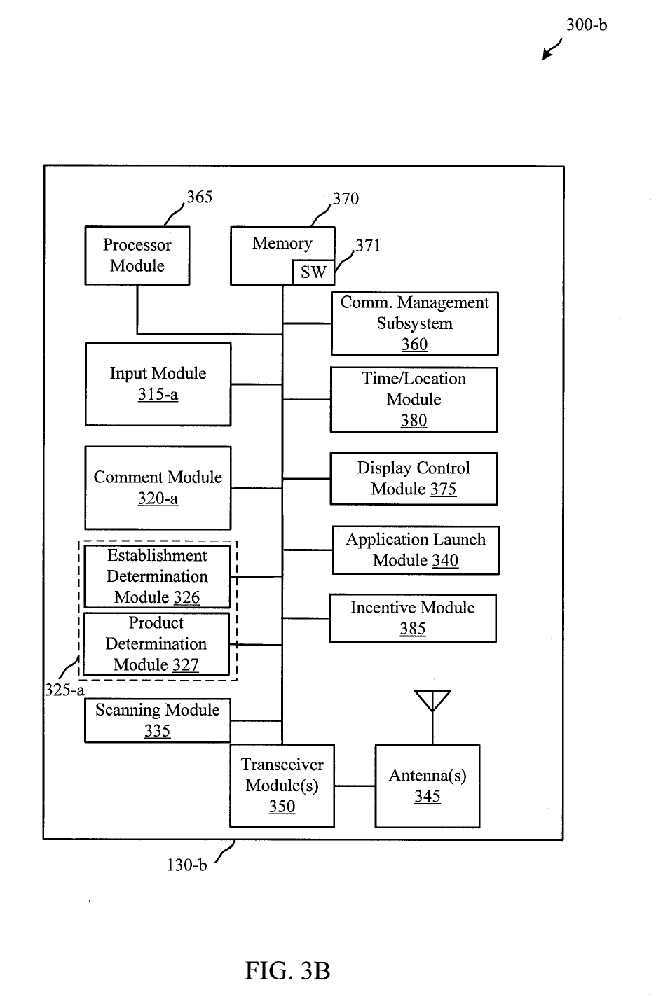

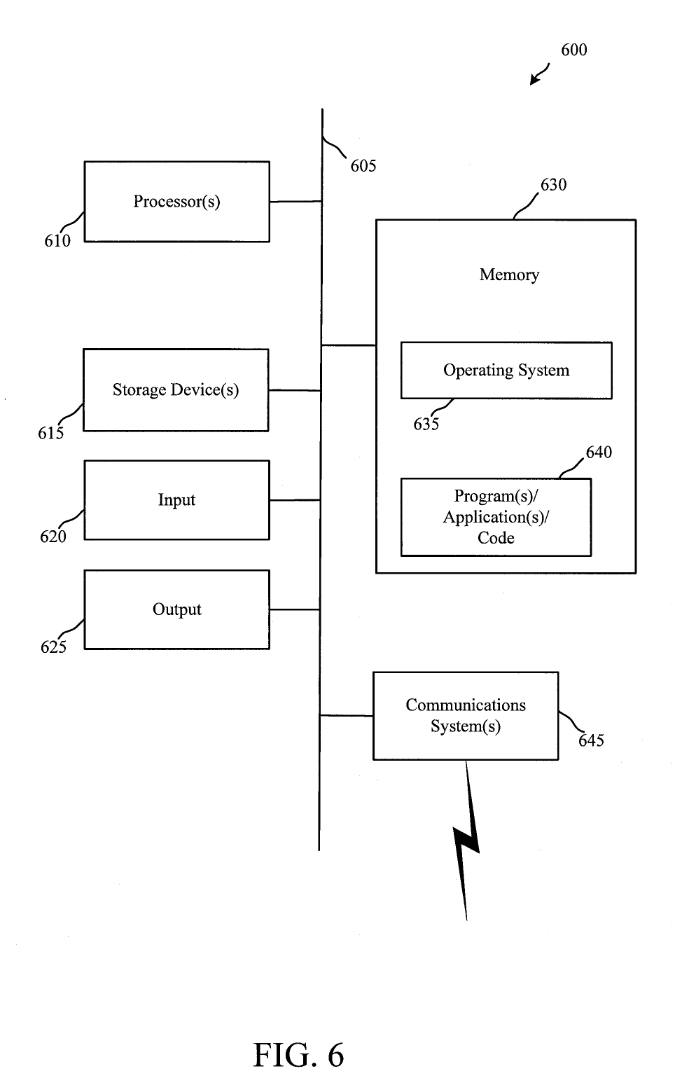

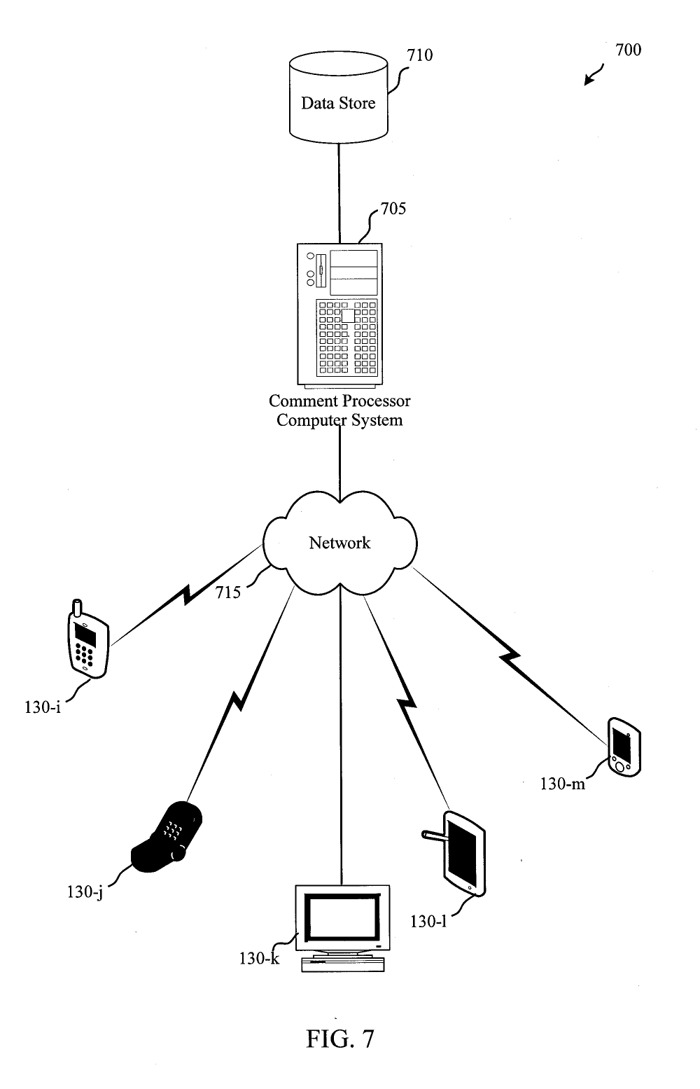

Turning next to FIG. 3A, a block diagram illustrates a device 300-a that may include unsolicited consumer comment acquisition functionality. The device 300-a may be an example of user devices such as user device 130 of FIGS. 1A-1D, device 130-a of FIGS. 2A-2B, device 130-b of FIG. 3B, system 600 of FIG. 6, and/or system 700 and/or devices 130-i, 130-j, 130-k, 130-l, and/or 130-m of FIG. 7. The device 300-a may also be a processor. The device 300-a may include a receiver module 310, an input module 315, a comment module 320, an establishment-product determination module 325, and/or a transmitter module 330. Each of these components may be in communication with each other.

These components of the device 300-a may, individually or collectively, be implemented with one or more application specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 310 may receive information from different sources including, but not limited to, user input and/or comment processor input. In some cases, the receiver module 310 may receive input from a user indicating that the user has one or more unsolicited comments directed to at least an establishment or an entity associated with a product may be received at a user device that may be utilized to determine an establishment and/or a product that the user has the one or more directed unsolicited comments. The establishment-product determination module 325 may be utilized in conjunction with the input module 315 to determine the establishment and or product. The comment module 320 may be utilized to generate for presentation to the user one or more comment input interfaces that may be transmitted through the transmitter module 330. One or more unsolicited comments may be received back through receiver 310 and/or input module 315 regarding at least the establishment or the product from the user. The transmitter module 330 may be utilized to transmit the one or more received unsolicited comments from device 300-a to a comment processor system, where the comment processor system may prepare the one or more unsolicited comments for presentation to at least the establishment or the entity associated with the product.

In some embodiments, the input module 315 and/or the establishment-product determination module 325 that may be utilized to determine at least the establishment or the product through presenting to the user multiple establishment types and/or multiple product types. The receiver module 310, input module 315 and/or the establishment-product determination module 325 may receive input from the user that the establishment-product determination module 325 may utilize to determine at least a specific establishment type from the multiple establishment types or a specific product type from the multiple product types may be determined based on input from the user. In some embodiments, the input module 315 and/or the establishment-product determination module 325 that may be utilized to determine at least the establishment or the product through presenting to the user multiple establishments and/or multiple products based on at least in part on the determined specific establishment type or the determined specific product type. The establishment-product determination module 325 may utilize a lookup table to determine the multiple establishments and/or products based on the determined specific establishment type and/or product type. The receiver module 310, input module 315 and/or the establishment-product determination module 325 may receive input from the user that the establishment-product determination module 325 may utilize to determine at least a specific establishment from the multiple establishments or a specific product of the multiple products.

In some embodiments, the transmitter module 330 and/or receiver module 310 may be configured to scan for at least an establishment identifier or a product identifier. The scanned information may be received by the receiver module 310 and may be utilized by the establishment product module 325 to determine at least the establishment or the product that the user may want to provide an unsolicited comment directed to the establishment and/or entity associated with the product.

The comment module 320 may be configured to generate a comment input interface that may include at least a positive comment window or a negative comment window. In some embodiments, the comment module may be configured to present to the user at least a positive comment and a negative comment choice. The receiver module 310 and/or input module 315 may receive information from the user to determine the positive comment choice or the negative comment choice. The comment module 320 may also be configured to present the comment input interface that may include at least the positive comment window or the negative comment window based on the determined positive comment choice or the determined negative comment choice.

In some embodiments, the transmitter module 330 may be configured to transmit to the comment processor system additional data including at least a time of day, a date, or a location of the user device.

FIG. 3B shows a block diagram 300-b of user device 130-b that may be an example of user devices 130 of FIGS. 1A-1D, 130-a of FIGS. 2A-2B, device 300-a of FIG. 3A, system 600 of FIG. 6, and/or devices 130-i, 130-j, 130-k, 130-l, and/or 130-m of FIG. 7. The user device 130-b may have any of various configurations, such as personal computers (e.g., laptop computers, net book computers, tablet computers, etc.), cellular telephones, PDAs, digital video recorders (DVRs), internet appliances, gaming consoles, e-readers, etc.

The user device 130-b may include antenna(s) 345, transceiver module(s) 350, input module 315-a, time/location module 380, display control module 375, application launch module 340, establishment determination module 326, product determination module 327, comment module 320-a, scanning module 335, memory 370, and/or processor module 365 which each may be in communication, directly or indirectly, with each other (e.g., via one or more buses). The transceiver module(s) 350 may be configured to communicate bi-directionally, via the antenna(s) 345 with a base station or other network device. Transceiver module(s) 350 may include a modem configured to modulate the packets and provide the modulated packets to the antenna(s) 345 for transmission, and to demodulate packets received from the antenna(s) 345. While the user device 130-b may include a single antenna, the multi-display device 110-d may include multiple antennas 345 for multiple links.

The memory 370 may include random access memory (RAM) and read-only memory (ROM). The memory 370 may store computer-readable, computer-executable software code 371 containing instructions that are configured to, when executed, cause the processor module 365 to perform various functions described herein (e.g., call processing, database management, message routing, etc.). Alternatively, the software 371 may not be directly executable by the processor module 365 but be configured to cause the computer (e.g., when compiled and executed) to perform functions described herein.

The processor module 365 may include an intelligent hardware device, e.g., a central processing unit (CPU) such as those made by Intel® Corporation or AMD®, a microcontroller, an application specific integrated circuit (ASIC), etc. The processor module 365 may include a speech encoder (not shown) configured to receive audio via a microphone, convert the audio into packets (e.g., 30 ms in length) representative of the received audio, provide the audio packets to the transceiver module(s) 350, and provide indications of whether a user is speaking. Alternatively, an encoder may only provide packets to the transceiver module(s) 350, with the provision or withholding/suppression of the packet itself providing the indication of whether a user is speaking.

According to the architecture of FIG. 3B, the user device 130-b may further include a communications management subsystem 360. The communications management subsystem 360 may manage communications with base stations, network devices, and/or other devices 130. In some cases, this communication may occur through a network. By way of example, the communications management subsystem 360 may be a component of the device 130-b in communication with some or all of the other components of the devices 130-b via a bus. Alternatively, functionality of the communications management subsystem 360 may be implemented as a component of a transceiver module(s) 350, as a computer program product, and/or as one or more controller elements of the processor module 365.

Some components of the device 130-b may, individually or collectively, be implemented, in whole or in part, with instructions embodied in a memory, formatted to be executed by one or more general or application-specific processors. They may also be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art.

The components for device 130-b may be configured to implement the aspects discussed above with respect to device 300-a in FIG. 3A and may not be repeated here for the sake of brevity. For example, the input module 315-a may be an example of the input module 315 of FIG. 3A. The comment module 320-a may be an example of the comment module 320 of FIG. 3A. The establishment determination module 326 and/or the product determination module 327 may combine to form an establishment-product determination module 325-a that may be an example of the establishment-product determination module 325. The transceiver module(s) 350 may be an example of the receiver module 310 and/or the transmitter module 330 of FIG. 3A.

In addition, device 130-b includes time/location module 380. Time/location module 380 may perform different functions, including providing time and/or location information associated with when a user may provide unsolicited comments. Time/location module 380 may include location components such as GPS and/or triangulation component. These location components may be utilized to determine the location of a user device when the user inputs unsolicited comments that are received by the device 130-b. In some cases, the location information may be utilized by the user device 130-b in conjunction with the establishment determination module 326 to determine the establishment that the user wants to direct the comment towards. Time/location module 380 may include a clock component.

Device 130-b may include a display control module 375. Display control module 375 may be utilized to control how the different comment input interfaces and/or other presented information may be presented to the user that may be part of or in communication with a device such as device 130-b. Display control module 375, for example, may be utilized to coordinate displaying the size and/or location of a window on display 130-b. Application launch module 340 may be utilized to launch applications on device 130-b, such as launching an unsolicited comment application in accordance with various embodiments. Device 130-b may also include a scanning module 335. Scanning module 335 may be utilized to scan for different establishment and/or product identifiers including, but not limited to, bar codes and RFID tags.

Device 130-b may include an incentive module 385. Incentive module 385 may be utilized to provide different incentives to the user to provide unsolicited comments. Incentive module 385 may be configured to present an incentive interface that may include a one or more incentives for the user to select. A user-selected incentive from the one or more incentives may be determined at the incentive module 385. Information regarding the user-selected incentive may be transmitted to the comment processor or other entity from the incentive module 385. For example, a user may select a specific charity to support as an incentive or benefit to them for providing an unsolicited comment. By selecting a specific charity, a donation or some other form of support may be provided to the charity by one or more entities, such as the comment processor, the specific establishment, and/or the entity associated with the product. This incentive or benefit may be provided to encourage users to provide unsolicited comments. Different incentives may be provided in other embodiments, including but not limited to, providing coupons, discounts, or other benefits to the user. In general, the incentives are provided in such a way that the user may maintain anonymity.

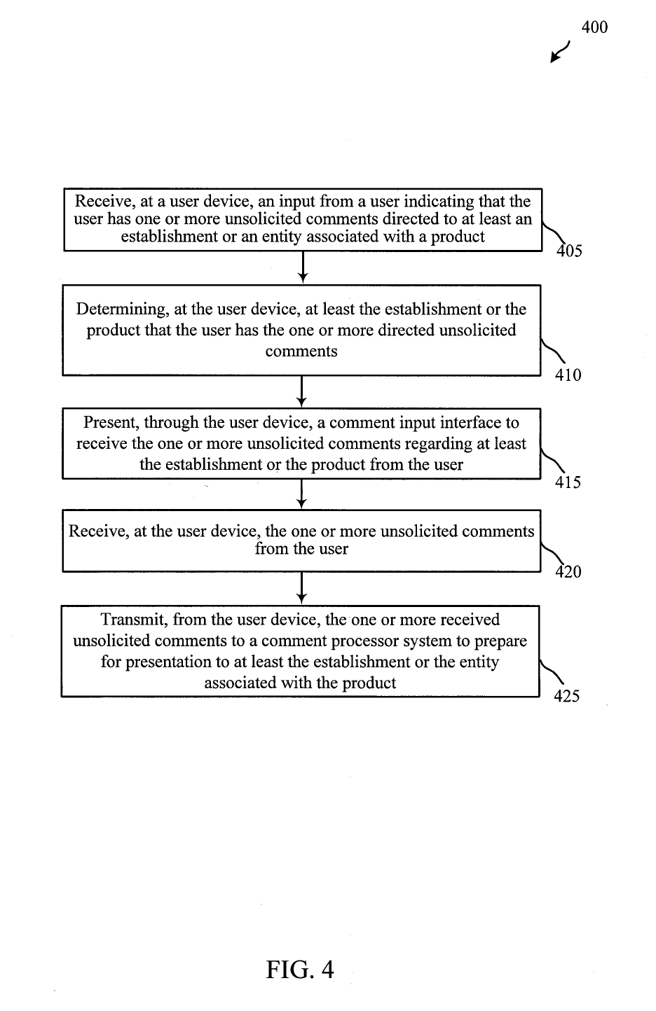

FIG. 4 shows a flow diagram of a method 400 for acquiring unsolicited consumer comments in accordance with various embodiments. Method 400 may be implemented on devices such as device 130 of FIGS. 1A-1D, device 130-a of FIGS. 2A-2B, device 300-a of FIG. 3A, device 130-b of FIG. 3B, system 600 of FIG. 6, and/or system 700 and/or devices 130-i, 130-j, 130-k, 130-l, and/or 130-m of FIG. 7.

At block 405, an input from a user indicating that the user has one or more unsolicited comments directed to at least an establishment or an entity associated with a product may be received at a user device. At block 410, at least the establishment or the product that the user has the one or more directed unsolicited comments may be determined at the user device. At block 415, a comment input interface to receive the one or more unsolicited comments regarding at least the establishment or the product from the user may be presented through the user device. At block 420, the one or more unsolicited comments from the user may be received at the user device. At block 425, the one or more received unsolicited comments may be transmitted, from the user device, to a comment processor system to prepare for presentation to at least the establishment or the entity associated with the product.

Determining, at the user device, at least the establishment or the product may include presenting to the user, through the user device, at least multiple establishment types or multiple product types. At least a specific establishment type from the multiple establishment types or a specific product type from the multiple product types may be determined based on input from the user. Determining, at the user device, at least the establishment or the product may further include presenting to the user, through the user device, at least multiple establishments or multiple products based on at least the determined specific establishment type or the determined specific product type. Some embodiments may utilize a lookup table to determine the multiple establishments and/or products based on the determined specific establishment type and/or product type. At least a specific establishment from the multiple establishments or a specific product of the plurality multiple products may be determined based on input from the user.

Determining, at the user device, at least the establishment or the product may include scanning for at least an establishment identifier or a product identifier. Scanned information may be received identifying at least the establishment or the product associated with at least the establishment identifier or the product identifier.

The comment input interface may include at least a positive comment window or a negative comment window. In some embodiments, the method 400 may further include presenting to the user, through the user device, at least a positive comment and a negative comment choice. The positive comment choice or the negative comment choice may be determined based on input from the user. Presenting, through the user device, the comment input interface may include presenting at least the positive comment window or the negative comment window based on the determined positive comment choice or the determined negative comment choice.

In some embodiments, the method 400 may further include transmitting to the comment processor system additional data including at least a time of day, a date, or a location of the user device.

In some embodiments, the method 400 may further include presenting an incentive interface comprising a one or more incentives for the user to select. A user-selected incentive from the one or more incentives may be determined. Information regarding the user-selected incentive may be transmitted to the comment processor or other entity, such as the establishment or entity associated with a product.

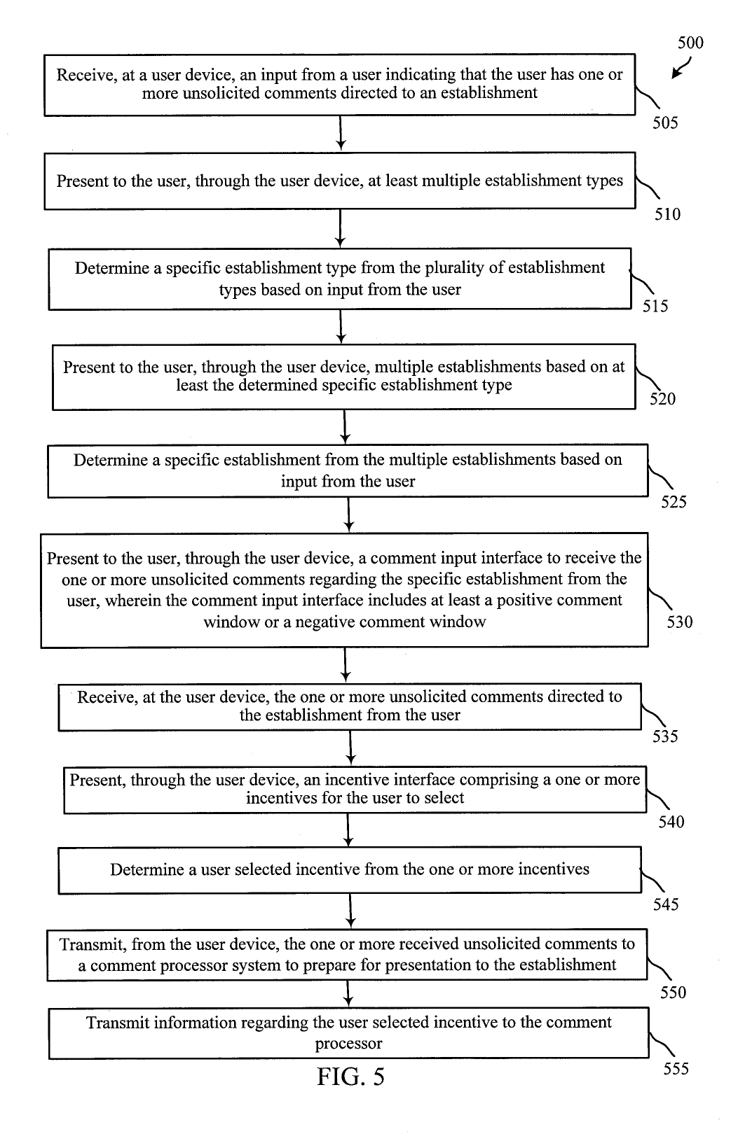

Turning to FIG. 5, a flow diagram of a method 500 for acquiring unsolicited consumer comments is provided in accordance with various embodiments. Method 500 may be implemented on devices such as device 130 of FIGS. 1A-1D, device 130-a of FIGS. 2A-2B, device 300-a of FIG. 3A, device 130-b of FIG. 3B, system 600 of FIG. 6, and/or system 700 and/or devices 130-i, 130-j, 130-k, 130-l, and/or 130-m of FIG. 7. Method 500 may include aspects of method 400.

At block 505, an input from a user may be received at a user device. The input may indicate that the user has one or more unsolicited comments directed to an establishment. At block 510, at least multiple establishment types may be presented to the user through the user device. At block 515, a specific establishment type from the multiple establishment types may be determined based on input from the user. At block 520, multiple establishments may be presented to the user, through the user device, based on at least the determined specific establishment type. At block 525, a specific establishment from the multiple establishments may be determined based on input from the user. At block 530, a comment input interface to receive the one or more unsolicited comments regarding the specific establishment from the user may be presented to the user through the user device. The comment input interface may include at least a positive comment window or a negative comment window. At block 535, the one or more unsolicited comments directed to the establishment from the user may be received at the user device. At block 540, an incentive interface that includes a one or more incentives for the user to select may be presented through the user device. At block 545, a user-selected incentive from the one or more incentives may be determined. At block 550, the one or more received unsolicited comments may be transmitting, from the user device, to a comment processor system to prepare for presentation to the establishment. At block 555, information regarding the user-selected incentive may be transmitted to the comment processor.

A computer system 600 that may use different methods for acquiring unsolicited consumer comments in accordance with various embodiments is illustrated with the schematic diagram of FIG. 6. This drawing broadly illustrates how individual system elements may be implemented, whether in a separated or more integrated manner. The exemplary structure is shown comprised of hardware elements that are electrically coupled via bus 605, including processor(s) 610 (which may further comprise a DSP or special-purpose processor), storage device(s) 615, input device(s) 620, and output device(s) 625. The storage device(s) 615 may be a machine-readable storage media reader connected to any machine-readable storage medium, the combination comprehensively representing remote, local, fixed, or removable storage devices or storage media for temporarily or more permanently containing computer-readable information. The communications system(s) 645 may interface to a wired, wireless, or other type of interfacing connection that permits data to be exchanged with other devices. The communications system(s) 645 may permit data to be exchanged with a network.

The system 600 may also include additional software elements, shown as being currently located within working memory 630, including an operating system 635 and other code 640, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

FIG. 7 illustrates a communication network system 700 that includes user devices 130-i, 130-j, 130-k, 130-l, and 130-m in accordance with various embodiments. Devices 130-i, 130-j, 130-k, 130-l, and/or 130-m may be examples of device 130 of FIGS. 1A-1D, device 130-a of FIGS. 2A-2B, device 300-a of FIG. 3A, device 130-b of FIG. 3B, and/or system 600 of FIG. 6. The user devices 130-i, 130-j, 130-k, 130-l, and 130-m may have any of various configurations, such as personal computers (e.g., laptop computers, net book computers, tablet computers, etc.), cellular telephones, PDAs, digital video recorders (DVRs), internet appliances, gaming consoles, e-readers, etc. The user devices 130-i, 130-j, 130-k, 130-l, and 130-m may communicate wirelessly (as shown with devices 130-i, 130-j, 130-l, and/or 130-m) and/or through wired connections (as shown with device 130-k) with network 715. Through network 715, user devices 130-i, 130-j, 130-k, 130-l, and/or 130-m may communicate with each other or other devices. User devices 130-i, 130-j, 130-k, 130-l, and/or 130-m may communicate in some cases with a comment processor computer system 705, which may be coupled with a data store 710. Comment processor computer system 705 may process unsolicited comments received from user devices 130-i, 130-j, 130-k, 130-l, and/or 130-m for presentation to an establishment and/or entity associated with a product to which the unsolicited comments may be directed.

Techniques described herein may be used for various wireless communications systems including, but not limited to, CDMA, TDMA, FDMA, OFDMA, SC-FDMA, and other systems for some embodiments. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for acquiring unsolicited consumer comments, the method comprising:
receiving, at a user device, an input from a user indicating that the user has one or more unsolicited comments directed to an establishment;
presenting to the user, through the user device, at least a plurality of establishment types;
determining a specific establishment type from the plurality of establishment types based on input from the user;
presenting to the user, through the user device, a plurality of establishments based on at least the determined specific establishment type; and
determining a specific establishment from the plurality of establishments based on input from the user;
presenting to the user, through the user device, a comment input interface to receive the one or more unsolicited comments regarding the specific establishment from the user, wherein the comment input interface includes at least a positive comment window or a negative comment window;
receiving, at the user device, the one or more unsolicited comments directed to the establishment from the user;
presenting, through the user device, an incentive interface comprising a one or more incentives for the user to select;
determining a user-selected incentive from the one or more incentives;
transmitting, from the user device, the one or more received unsolicited comments to a comment processor system to prepare for presentation to the establishment; and
transmitting information regarding the user-selected incentive to the comment processor system.

2. A method for acquiring unsolicited consumer comments, the method comprising:
receiving, at a user device, an input from a user indicating that the user has one or more unsolicited comments directed to at least an establishment or an entity associated with a product;
determining, at the user device, at least the establishment or the product that the user has the one or more directed unsolicited comments;
presenting, through the user device, a comment input interface to receive the one or more unsolicited comments regarding at least the establishment or the product from the user;
receiving, at the user device, the one or more unsolicited comments from the user; and
transmitting, from the user device, the one or more received unsolicited comments to a comment processor system to prepare for presentation to at least the establishment or the entity associated with the product.

3. The method of claim 2, wherein determining, at the user device, at least the establishment or the product comprises:
presenting to the user, through the user device, at least a plurality of establishment types or a plurality of product types; and
determining at least a specific establishment type from the plurality of establishment types or a specific product type from the plurality of product types based on input from the user.

4. The method of claim 3, wherein determining, at the user device, at least the establishment or the product further comprises:
presenting to the user, through the user device, at least a plurality of establishments or a plurality of products based on at least the determined specific establishment type or the determined specific product type; and
determining at least a specific establishment from the plurality of establishments or a specific product of the plurality of products based on input from the user.

5. The method of claim 2, wherein determining, at the user device, at least the establishment or the product comprises:
scanning for at least an establishment identifier or a product identifier; and
receiving scanned information identifying at least the establishment or the product associated with at least the establishment identifier or the product identifier.

6. The method of claim 2, wherein the comment input interface comprises at least a positive comment window or a negative comment window.

7. The method of claim 6, further comprising:
presenting to the user, through the user device, at least a positive comment choice or a negative comment choice;
determining the positive comment choice or the negative comment choice based on input from the user; and wherein:
presenting, through the user device, the comment input interface comprises presenting at least the positive comment window or the negative comment window based on the determined positive comment choice or the determined negative comment choice.

8. The method of claim 2, further comprising:
transmitting to the comment processor system additional data including at least a time of day, a date, or a location of the user device.

9. The method of claim 2, further comprising:
presenting, through the user device, an incentive interface comprising a one or more incentives for the user to select;
determining a user-selected incentive from the one or more incentives; and
transmitting information regarding the user-selected incentive to at least the comment processor, the establishment, or the entity associated with the product.

10. A user device for acquiring unsolicited consumer comments, the user device comprising:
an input module configured to:
receive an input from a user indicating that the user has one or more unsolicited comments directed to at least an establishment or an entity associated with a product; and
receive the one or more unsolicited comments from the user;
an establishment-product determination module configured to determine at least the establishment or the product that the user has the one or more directed unsolicited comments;
a comment module configured to present a comment input interface to receive the one or more unsolicited comments regarding at least the establishment or the product from the user; and
a transmitter module configured to transmit the one or more received unsolicited comments to a comment processor system to prepare for presentation to at least the establishment or the entity associated with the product.

11. The user device of claim 10, wherein the establishment-product determination module configured to determine at least the establishment or the product is configured to:
present to the user at least a plurality of establishment types or a plurality of product types; and
determine at least a specific establishment type from the plurality of establishment types or a specific product type from the plurality of product types based on input from the user.

12. The user device of claim 11, wherein the establishment-product determination module configured to determine at least the establishment or the product is further configured to:
present to the user at least a plurality of establishments or a plurality of products based on at least the determined specific establishment type or the determined specific product type; and
determine at least a specific establishment from the plurality of establishments or a specific product of the plurality of products based on input from the user.

13. The user device of claim 10, wherein the establishment-product determination module configured to determine at least the establishment or the product is configured to:
scan for at least an establishment identifier or a product identifier; and
receive scanned information identifying at least the establishment or the product associated with at least the establishment identifier or the product identifier.

14. The user device of claim 10, wherein the comment module configured to present the comment input interface is configured to at least a positive comment window or a negative comment window.

15. The user device of claim 14, wherein the comment module configured to present a comment input interface is further configured to:
present to the user at least a positive comment choice and a negative comment choice;
determine the positive comment choice or the negative comment choice based on input from the user; and wherein:
presenting the comment input interface comprises presenting at least the positive comment window or the negative comment window based on the determined positive comment choice or the determined negative comment choice.

16. The user device of claim 10, wherein the transmitter module is further configured to:
transmit to the comment processor system additional data including at least a time of day, a date, or a location of the user device.

17. The user device of claim 10, wherein the user device is a mobile device.

18. The user device of claim 10, further comprising an incentive module configured to:
present an incentive interface comprising a one or more incentives for the user to select;
determine a user-selected incentive from the one or more incentives; and
transmit information regarding the user-selected incentive to at least the comment processor, the establishment, or the entity associated with the product.

19. A computer program product for acquiring unsolicited consumer comments on a tangible processor-readable medium and comprising processor-readable instructions, which, when executed, cause a processor to perform steps comprising:
receiving, at a user device, an input from a user indicating that the user has one or more unsolicited comments directed to at least an establishment or an entity associated with a product;
determining, at the user device, at least the establishment or the product that the user has the one or more directed unsolicited comments;
presenting, through the user device, a comment input interface to receive the one or more unsolicited comments regarding at least the establishment or the product from the user;
receiving, at the user device, the one or more unsolicited comments from the user; and
transmitting, from the user device, the one or more received unsolicited comments to a comment processor system to prepare for presentation to at least the establishment or the entity associated with the product.

20. The computer program product of claim 19, wherein determining, at the user device, at least the establishment or the product comprises:
presenting to the user, through the user device, at least a plurality of establishment types or a plurality of product types; and
determining at least a specific establishment type from the plurality of establishment types or a specific product type from the plurality of product types based on input from the user.

21. The computer program product of claim 20, wherein determining, at the user device, at least the establishment or the product further comprises:
presenting to the user, through the user device, at least a plurality of establishments or a plurality of products based on at least the determined specific establishment type or the determined specific product type; and
determining at least a specific establishment from the plurality of establishments or a specific product of the plurality of products based on input from the user.

22. The computer program product of claim 19, wherein determining, at the user device, at least the establishment or the product comprises:
scanning for at least an establishment identifier or a product identifier; and
receiving scanned information identifying least the establishment or the product associated with at least the establishment identifier or the product identifier.

23. The computer program product of claim 19, wherein the comment interface comprises at least a positive comment window or a negative comment window.

24. The computer program product of claim 23, further comprising:
presenting to the user, through the user device, at least a positive comment choice and a negative comment choice;
determining the positive comment choice or the negative comment choice based on input from the user; and wherein:
presenting, through the user device, the comment input interface comprises presenting at least the positive comment window or the negative comment window based on the determined positive comment choice or the determined negative comment choice.

25. The computer program product of claim 19, further comprising:
transmitting to the comment processor system additional data including at least a time of day, a date, or a location of the user device.

26. The computer program product of claim 19, further comprising:
presenting an incentive interface comprising a one or more incentives for the user to select;
determining a user-selected incentive from the one or more incentives; and
transmitting information regarding the user-selected incentive to at least the comment processor, the establishment, or the entity associated with the product.
